(19) United States
(12) Patent Application Publication
(10) Pub. No.: US 2003/0009596 A1
(43) Pub. Date: Jan. 9, 2003

(54) Method for programming code compression using block sorted compression algorithm, processor system and method for an information delivering service using the code compression

(76) Inventor: Motonobu Tonomura, Kodaira (JP)

Correspondence Address: REED SMITH HAZEL & THOMAS LLP, Suite 1400, 3110 Fairview Park Drive, Falls Church, VA, 22042, US

(21) Appl. No.: 09/945,708

(22) Filed: Sep. 5, 2001

(30) Foreign Application Priority Data
Jul. 9, 2001 (JP) 2001-207730

(51) Int. Cl. G06F 15/16; H04J 3/18; G06F 17/00; G06F 7/00

(52) U.S. Cl. 709/247; 370/477; 707/101

(57) ABSTRACT

Program code must be compression-encoded so that the encoded program code can be decoded from a random branch address. Furthermore, it is necessary to exchange information written in a virtual machine language independent from any architecture. The present invention performs compression encoding by use of a block sorting compression algorithm so that the relationships between current sorting position numbers and previous sorting position numbers are stored, making it possible to perform direct decoding starting from a random branch address indicated by a branch instruction. Furthermore, the present invention directly interprets and executes compressed virtual machine word strings at the time of decoding. Program code can be compressed by use of a block sorting compression algorithm having a compression ratio as high as one obtained for text data, making it possible to exchange information independently from any architectures.

### BACKGROUND OF THE INVENTION

The present invention relates to a technique for compressing/decompressing program code, and more particularly to a compression programming method suitable for efficiently compressing program code in an executable form and executing compressed instruction code while decompressing it. The present invention also relates to a method for providing information as to compressed program code and a processor system using the compression programming method.

Since embedded-type processors used for portable equipment and controllers are limited as to the capacity of their built-in memory, their available program capacity is small. This limitation is attributed to the fact that it is substantially impossible to use a secondary storage device such as a hard disk. Accordingly, it is desired that a processor architecture having a code efficiency as high as possible be devised.

For example, some processors which have a 32-bit-length instruction code architecture employ additional instruction codes for reducing the length of their instruction codes to 16 bits (half of their original length). The reducing instruction codes, etc. are described in the literature: S. Segars, K. Clarke, and L. Goudge, “Embedded Control Problems, Thumb and the ARM7TDMI”, IEEE Micro, vol. 15, no. 5, pp. 22-30, October 1995.

As the above example indicates, the compressed instruction code is decompressed and converted so that it can be decoded during the execution. Therefore, this method has an advantage in that since the compressed code is stored in a cache memory, the apparent cache capacity increases, reducing the occurrence of a cache miss. However, since instructions whose code can be shortened is limited to a part of the instruction sets, no large compression effect can be expected.

Another proposal decompresses compressed instruction code before it is loaded into a cache memory. However, this technique has no effect for reduction of the occurrence of a cache miss. Since there is a difference in the branch instruction address between the cache memory which stores the decompressed code and the main memory which stores the compressed code, a method has been proposed to convert instruction code so that it specifies the branch destination address of its compressed code.

Furthermore, a branch destination address whose code is compressed may indicate a point in the middle of an address of compressed code, complicating the system. Therefore, the branch destination addresses are usually limited so as to indicate the heads of compressed code. In addition, since compressed code crossing a boundary of an access unit also complicates the system, a limit has been proposed to be put on the boundaries. It should be noted that whether the expansion of compressed code is carried out before or after loading of the code into a cache memory, a conventional instruction decoder can be used as it is after the expansion, eliminating the need for changing the programming model.

As described above, since program code has branch instructions, its compressed code must be able to be decompressed at random positions. The LZ compression method, which was proposed by Ziv and Lempel in 1977, is often used to compress serial data such as text and files. The LZ compression method regards part of flowing data as a window, and lexicographically and dynamically self-references it using a pointer. Accordingly, this method cannot randomly perform the expansion, and therefore is difficult to use for compression of program code. It should be noted that the LZ compression method is described in the literature: “A Universal Algorithm for Sequential Data Compression”, IEEE Trans. on Inform. Theory, vol. IT-23, no. 3, pp. 337-349, May 1977.

To increase the compression efficiency of program code, use of the Huffman coding method, etc. which has a static dictionary over the entire program has been considered. The Huffman coding method is described in the literature: M. Kozuch and A. Wolfe, “Compression of Embedded System Programs, Proc. of ICCD '94, pp. 270-277, 1994.

However, since Huffman coding uses a variable-length system in which code of a high occurrence frequency is shortened, it is complicated to implement compression of program code whose length is long. Accordingly, a modified coding system must be devised so that the length does not exceed a certain value. Furthermore, since Huffman coding uses prefix code (in which each code word has no head substring which coincides with that of another code word), it is necessary to perform decoding from the head of each code word sequentially. That is, it is not possible to decode branched code starting from its middle position; the starting position must be the head of each code word. Satisfying this condition reduces the compression efficiency of code. Arithmetic coding is easy to employ variable-length code, as compared with Huffman coding. Its application to the compression of program code is proposed in the literature: H. Lekatsas and W. Wolf, “SAMC: A Code Compression Algorithm for Embedded Processors”, IEEE Trans. Computer-Aided Design of Integrated Circuits and Systems, vol. 18, no. 12, pp. 1689-1701, December 1999.

However, to realize branching operation, the above application of Arithmetic coding handles code in units of blocks which each has byte boundaries so as to perform branching in units of bytes. Compression code dedicated for branching is provided for that purpose. This means that the above application loses much of the compression efficiency inherent to Arithmetic coding.

Another characteristic of program code is that it is divided into an opcode portion and an operand portion, and their occurrence patterns and frequencies are different from each other. Generally, the occurrence patterns of opcode portions are repeated, while the occurrence patterns of operand portions have various shapes. As a result, patterns of instruction codes tend to vary considerably, which lowers the code compression efficiency.

Some high-performance architectures use VLIW (Very Long Instruction Word) to derive a maximum of their parallel executability. These methods using VLIW are disadvantageous in that they have instructions which have long word lengths and many invalid fields, resulting in large program code size due to lowered code efficiency.

Incidentally, program code is not necessarily written in the target machine language. It may be written in intermediate code such as a Java language, and executed on the target architecture through its interpreter or compiler. Web browsers are often used since use of a Web browser makes it possible for the receiving side to process and display transmitted indication information on any machine.

Thus, since program code of large code size written by use of intermediate code forms a communications bottleneck, compression of the code is required in such a case. The interpretation and execution of intermediate code by an interpreter is inherently slower than the direct execution of compiled code. Therefore, the expansion and interpretation of compressed and transmitted intermediate code on the receiving side doubles the load.

It is desired to solve the above problems.

A first object of the present invention is to provide a compression programming method using a block sorting compression algorithm, and a processor system using the compression programming method.

A second object of the present invention is to provide a high-efficiency compression method handling program code even in a VLIW form, which tends to produce a program of large size.

### SUMMARY OF THE INVENTION

To solve the above problems, the present invention employs the following methods.

For example, consider a compression method other than Huffman coding and Arithmetic coding. Recently, there has been a growing interest in the theoretical aspect of another compression method called the block sorting compression method whose compression ratio is high and comparable to that of the LZ compression method.

The block sorting compression method is described in the literature: P. Fenwick, P. M. “Blocksorting text compression—Final report”, Technical Report 130, Department of Computer Science, University of Auckland, Auckland, New Zealand, 1996.

The block sorting compression method creates cyclic shift (or rotational shift) strings using entire text data, and sorts all the generated cyclic shift strings in a lexicographical order, and extracts the last column to code it. Since the last column tends to include series of a same text symbol, the text data can be compressed by coding the series.

Since the decoding principle of the block sorted compressed data makes it possible to derive a method for randomly (meaning starting from anywhere) decoding the data, the block sorting compression method can be applied to compression of program code. In the block sorting compression method, entire program code can be sorted, grouped, and thereby efficiently encoded to increase the total compression ratio. To directly decode compressed program code encoded by use of the block sorting compression method, a method is adopted in which the compression encoding is carried out by storing the positional relationships between code strings obtained before and after sorting, starting from the beginning.

Further, in a VLIW system, each field obtained as a result of parallel division is sorted to efficiently perform compression without reducing the parallelism inherent to VLIW. When compressing intermediate code strings, the instructions are decompressed and directly interpreted at the same time, realizing high-speed execution.

In addition to the above methods for solving the above problems, the present invention provides a compression programming method which comprises the steps of: setting a plurality of codes corresponding to a plurality of commands which constitutes an arbitrary program; and sorting the plurality of codes by use of a compression algorithm before arranging and compression-encoding the plurality of codes.

Further, the present invention provides a compression programming method which comprises the steps of: in an instruction form having a plurality of instruction fields, combining fields of an instruction into a plurality of instruction blocks, and compressing and sorting the plurality of instruction blocks for each block position; mixing, merging, and arranging the sorted plurality instruction code strings; compression-encoding the arranged plurality of instruction code strings; and performing decoding for each block in parallel at a time of decoding.

Still further, the present invention provides a processor system using a compression programming method, the processor system comprising: a setting unit for setting a plurality of codes corresponding to a plurality of commands which constitutes an arbitrary program; and a compression unit for sorting the plurality of codes by use of a compression algorithm before arranging and compression-encoding the plurality codes.

Still further, the present invention provides a processor system using a compression programming method, the processor system comprising: a sorting unit for, in an instruction form having a plurality of instruction fields, combining fields of an instruction into a plurality of instruction blocks, and compressing and sorting the plurality of instruction blocks for each block position; means for mixing, merging, and arranging the sorted plurality of instruction code strings; a compression unit for compression-encoding the arranged plurality of instruction code strings; and a decoding unit for performing decoding for each block in parallel at a time of decoding.

Still further, the present invention provides an information communication system for controlling transfer of information such as program code, the information communication system comprising: a transmission side terminal having an information transfer unit for controlling information transfer as to program code strings compressed by use of a block sorting compression algorithm; and a reception side terminal for receiving the program code strings subjected to the information transfer; wherein the reception side terminal is capable of directly decoding and interpreting the program code strings.

Still further, the present invention provides an information delivery service method for program code, the information delivery service method comprising the steps of: receiving program code compressed by use of a block sorting compression algorithm and delivered from a transmission side terminal, this step being performed by a reception side terminal; after completion of reception of the program code, notifying the transmission side terminal of the completion of reception, this step being performed by the reception side terminal; and being capable of directly decoding, interpreting, and executing the compressed program code, this step being performed by the reception side terminal.

Still further, the present invention provides a processor system which comprises: a plurality of memory elements having a compressed instruction area which stores compressed program code; a processor operating by use of a compression algorithm; and an interpreter being capable of directly decoding, interpreting, executing the program code by use of the compression algorithm.

### BRIEF DESCRIPTION OF THE DRAWINGS

FIG. 1 is a diagram showing the blocks of a processor which decodes, interprets, and executes compressed program code according to the present invention;

FIG. 2 is a diagram showing a program example for a machine;

FIG. 3 is a diagram showing a table indicating the corresponding relationships among mnemonics, short codes, and machine words used in the program example;

FIG. 4 is a diagram in which the program example is expressed by use of short code and sorted to show a compression state;

FIG. 5 is a diagram showing sorting and arranging of the program example;

FIG. 6 is a diagram showing a table which indicates compression of the program example in which the relationships between current sorting position numbers and previous sorting position numbers are stored;

FIG. 7 is a diagram showing a table which indicates compression encoding;

FIG. 8 is a diagram showing a parallel arrangement process of VLIW program code;

FIG. 9 is a diagram showing insertion operation of dummy branches in a VLIW system;

FIG. 10 is a block diagram showing a system in which program code written in a conventional intermediate language is transmitted and received before it is interpreted and executed by a virtual machine; and

FIG. 11 is a block diagram showing a system in which program code written in an intermediate language of the present invention is compressed, transmitted, and received before it is decoded and directly interpreted and executed by a virtual machine.

### DETAILED DESCRIPTION OF THE PREFERRED EMBODIMENTS

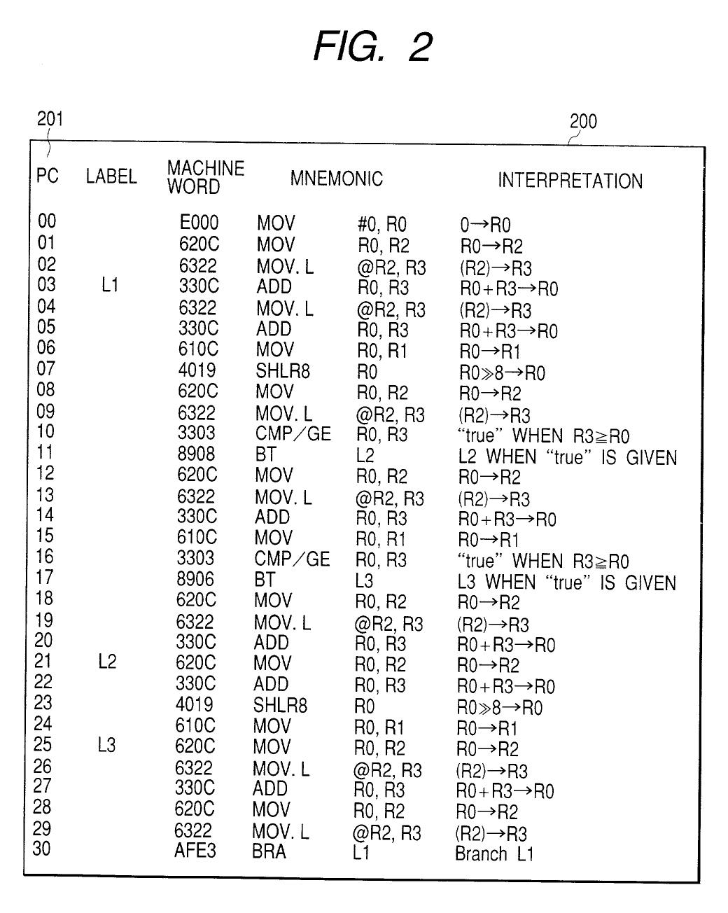

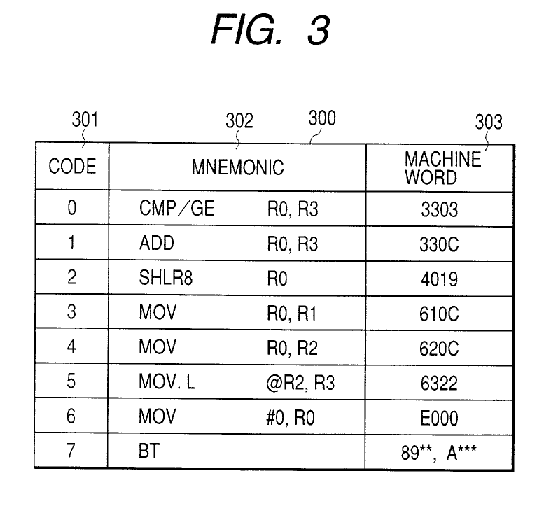

To explain a compression programming method of the present invention using the block sorting compression algorithm, which is one of compression algorithms, the following description uses program example 200 (shown in FIG. 2) made up of 31 processor commands each having a 16-bit instruction word. The commands are expressed using 8 types of machine words (machine word field 303) as shown in table 300 of FIG. 3. The table (each command) also includes a short code field 301 and a mnemonic field 302 corresponding to the short code field 301. Registers R0, R1, and R2 are used. The expression “@R2” indicates that a memory address indicated by the contents of the register R2 is referenced. The expression “#0” indicates that an immediate value of 0 is referenced.

The comparison instruction is expressed as “CMP/GE R0, R3” in the mnemonic field 302. If R3 is equal to or larger than R0, branching to a specified branch address occurs. This comparison instruction is hexadecimally represented by the machine word “3303” shown in the machine word field 303. Its short code is “0”.

The addition instruction is expressed as “ADD R0, R3” in the mnemonic field 302. It adds the contents of the register R0 to the contents of the register R3, and stores the result in the register R0 (R0+R3→R0). This instruction is represented by the machine word “330C” shown in the machine word field 303. Its short code is “1”.

The shift instruction is expressed as “SHLR8 R0” in the mnemonic field 302. It shifts the contents of the register R0 by 8 bits to the right, and stores the result in the register R0 (R0>>8→R0). This instruction is represented by the machine word “4019” shown in the machine word field 303. Its short code is “2”.

The transfer instruction 1 is expressed as “MOV R0, R1” in the mnemonic field 302. It stores the contents of the register R0 into the register R1 (R0→R1). This instruction is represented by the machine word “610C” in the machine word field 303. Its short code is “3”.

The transfer instruction 2 is expressed as “MOV R0, R2” in the mnemonic field 302. It stores the contents of the register R0 into the register R2 (R0→R2). This instruction is represented by the machine word “620C” in the machine word field 303. Its short code is “4”.

The transfer instruction 3 is expressed as “MOV @R2, R3” in the mnemonic field 302. It stores the contents of a memory address indicated by the contents of the register R2 into the register R3 ((R2)→R3). This instruction is represented by the machine word “6322” in the machine word field 303. Its short code is “5”.

The transfer instruction 4 is expressed as “MOV #0, R0” in the mnemonic field 302. It stores a numerical value of 0 into the register R0 (0→R0). This instruction is represented by the machine word “E000” in the machine word field 303. Its short code is “6”.

The branch instruction is expressed as “BT” in the mnemonic field 302. If the branch flag is “TRUE”, branching to branch destination L occurs. This instruction is represented by the machine word “89**”. Its short code is “7”. The symbol “**” included in the machine word “89**” indicates a specific branch destination address, and how to specify (embed) the branch destination address will be described later.

The conditional branch instruction “BRA” (its machine word is “A***”) is included in BT and has the same short code “7”. How to discriminate “89**” from “A***” will be also described later. FIG. 2 includes a program counter (PC) field 202 to indicate the execution order of the actual program based on the table 300 shown in FIG. 3.

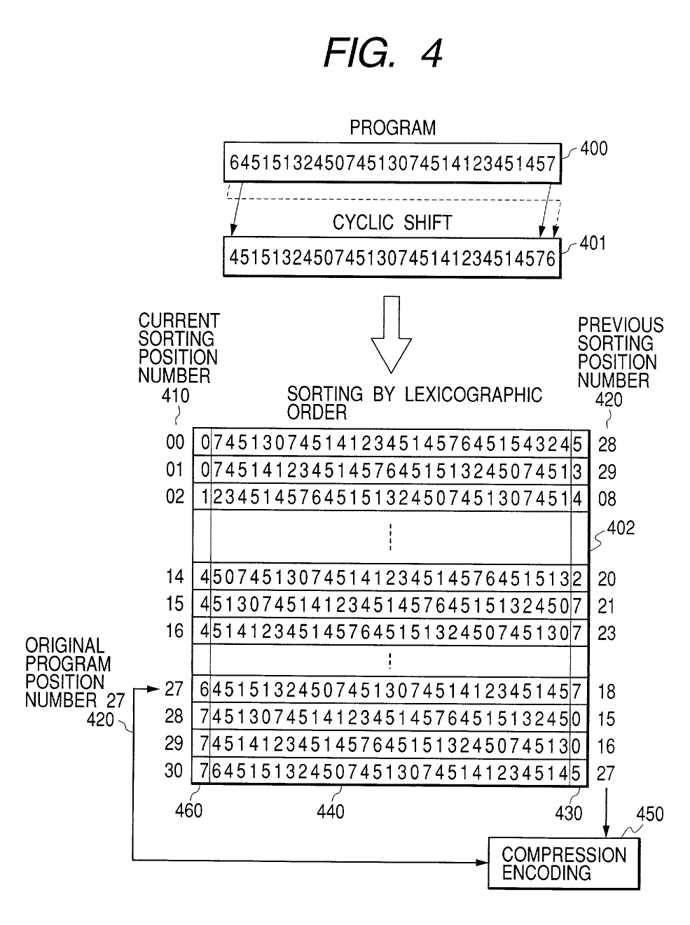

Each 16-bit instruction code included in the program example 200 of FIG. 2 is arranged in the order of the program counter value. Specifically, as shown in FIG. 4, the program instruction code string is expressed using short codes in the short code field 301 at step 400. Step 401 cyclically shifts the program instruction code string by one instruction code at a time to the left. The obtained short code strings are sorted in a defined order such as a lexicographical order, or increasing or decreasing order of the value of the short code to produce the array 440 at step 402.

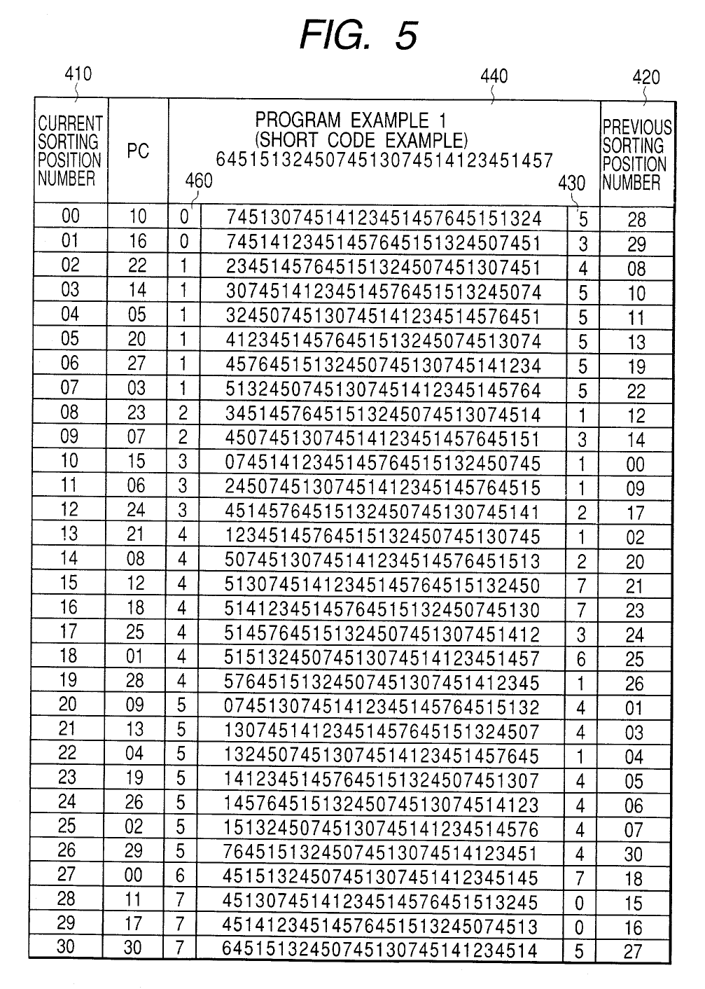

FIG. 5 shows the details of the array 440 shown in FIG. 4. A current sorting position number 410 is given to each sorted array string. Naturally, in the head column field 460 included in the array field 440, same short codes tend to gather as series in the increasing order of the value of the short code. Furthermore, as described above, the array 440 (the array field 440) is produced by cyclically shifting the program instruction code string and sorting the obtained code in a defined order such as a lexicographical order, or increasing or decreasing order of the value of the code. Therefore, also in the last column field 430 included in the array field 440, same short codes tend to gather as series, though not as much as in the head column field 460.

The original block sorting compression method carries out compression encoding using the characteristic that same short codes tend to gather as a series in the last column field 430. Its decoding is performed as follows. Assume that the compression encoding has been carried out using one of several compression encoding methods. At the first step, the compressed code is decompressed to obtain the last column field 430. The head column 460 field is automatically determined through cyclic shifts. At the second step (last step), the previous sorting position number field 420 for each last column field 430 is associated with the current sorting position number field 410 after sorting.

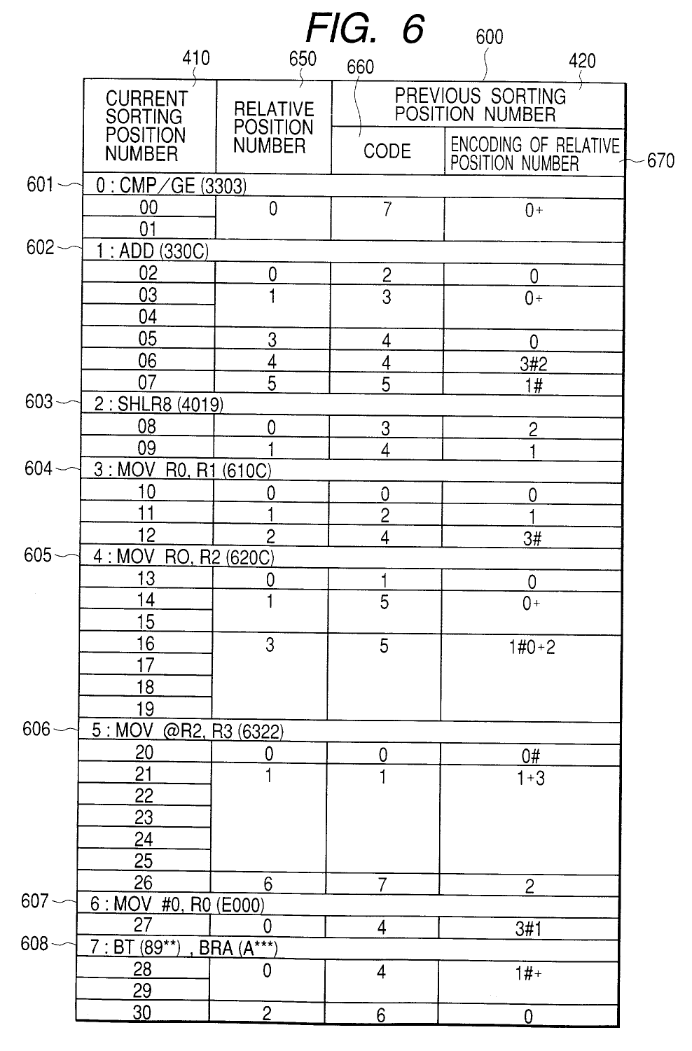

As described above, the original block sorting compression method carries out the coding operation in two steps. However, to directly (in a single step) carry out the coding operation, the present invention performs compression encoding on the table 600 of FIG. 6, which indicates the corresponding relationship between the previous sorting position number field 420 and the current sorting position number field 410, using the last column field 430 and stores the table, instead of performing compression encoding on the last column 430.

As described above, it is necessary to create the table 600, which indicates the corresponding relationship between the previous sorting position number field 420 and the current sorting position number 410 field before performing compression encoding on the table and storing it. A specific example of the table 600 (FIG. 6) will be described. To increase the efficiency of compression encoding, this example uses a relative position number 650 for each short code instead of an absolute current sorting position number 410 (or an absolute value number field 410).

For example, the ADD instructions (“330C”), which are indicated by reference numeral 602 in FIG. 6 and whose short code is “1”, have a code value of 1 in the head column field 460 and the current sorting position numbers “02” to “07” in FIG. 5. These current sorting position numbers “02” to “07” in FIG. 5 are expressed as (correspond to) the relative position numbers “0” to “5” in FIG. 6. The short code value “1” remains the same. That is, the 6 records (code strings) which have the current sorting position numbers “02” to “07” and a short code of “1” in FIG. 5 are given the corresponding serial numbers “0” to “5” in the relative position number field 650 starting from the reference number “0” in FIG. 6. It should be noted that even though the relative position number “2” corresponds to the current sorting position number “04”, the table omits the entry of this relative position number.

Accordingly, the values “2”, “3”, “3”, “4”, “4”, and “5” in the short code field 660, which corresponds to the previous sorting position number field 420 of FIG. 5, correspond to (are the same as) the short codes indicated in the head field 460 obtained as a result of cyclically shifting the code strings which have the current sorting position numbers “02” to “07” and the previous sorting position numbers “08”, “10”, “11”, “13”, “19”, and “22”. The following describes symbols indicated in the “encoding of relative position number” field included in the previous sorting position number field 420. In the case of the ADD instructions (“330C”), which are indicated by reference numeral 602 in FIG. 6, the symbols indicate the current sorting position numbers and the respective relative position numbers indicated by the destination short codes in the short code field 660.

For example, the “encoding of relative position number” “0” for the short code “2” indicates, as its destination command, the record including the current sorting position number “08” and the relative position number “0” for the mnemonic “SHLR8”. The “encoding of relative position number” “0+” for the short code “3” indicates, as its destination command, the record including the current sorting position number “11” and the relative position number “1” for the mnemonic “MOV R0, R1”. The “encoding of relative position number” “0” for the first one of the two short codes “4” indicates, as its destination command, the record including the current sorting position number “13” and the relative position number “0” for the mnemonic “MOV R0, R2”. The “encoding of relative position number” “3#2” for the second one of the two short codes “4” indicates, as its destination command, the record including the current sorting position number “19” and the relative position number “3” for the mnemonic “MOV R0, R2”. The “encoding of relative position number” “1#” for the last short code “5” indicates, its destination command, the record including the current sorting position number “22” and the relative position number “1” for the mnemonic “MOV @R2, R3”.

Thus, in order to efficiently perform compression encoding, when relative numbers (which are values in the “encoding of relative position number” field 670) are given serially, such as the relative number “p” and the relative number “p+1”, the series is expressed as “p+” using the “+” symbol. Furthermore, when j+2 relative numbers are serially given, such as p, p+1, . . . , and p+j, where j is a number larger than 0, the series is expressed as “p+j”. In the case where a series of relative numbers are given, when it is necessary to indicate the relative number “p+1+i”, the expression “p#i” is used to indicate only the entry point “p”. However, when i is 0, the expression “p#” is used.

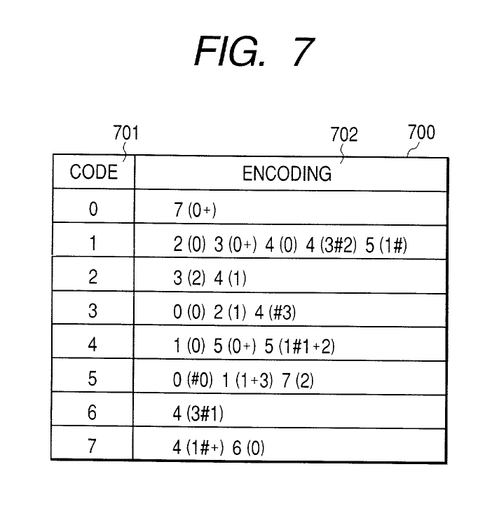

By using the table 600 in FIG. 6 prepared as described above, compression encoding is carried out as shown in the table 700 in FIG. 7. The codes in the short code field 701 of FIG. 7 are the same as those indicated by reference numerals 601 to 608 in FIG. 6. The code symbols (in the coding field 702) in FIG. 7 use the code symbols in the code field 660 and the code symbols in the “encoding of relative numbers” field included in the previous sorting position number field 420. For each short code in the code field 701, a short code (denoted by, for example, q) in the previous sorting position number field 420 in FIG. 6 is pointed at, and how many relative numbers follow the relative number p is indicated. It should be noted that the compression encoding is carried out after removing the delimiters “(“and ”)”. Furthermore, encoding is also performed on the short code “6” and the relative position number “0” indicated by reference numeral 607 in FIG. 6, which correspond to the starting original program position number “27” indicated by reference numeral 402 in FIG. 4. By performing compression encoding as described above, it is possible to directly carry out the decoding operation.

In the compressed code in FIG. 7 obtained as a result of compression-encoding the program example 200 in FIG. 2, for example, the decoding operation is started from the relative position number “0” for the short code “6” (instruction code “E000”) of FIG. 6. Therefore, the current instruction code is “E000” at this time point. Decoding operation is performed to obtain the machine word “E000” (instruction) indicated by the value “00” in the program counter (PC) field 201 in FIG. 2, and the instruction is executed.

The next instruction code “620C” indicated by the value “01” in the PC field is obtained as follows. First, the relative position number “0” (FIG. 6) which is an entry in the short code “6” of FIG. 7 is read. Then, the short code “4” (instruction code “620C”) and the value “3#1” in the “encoding of relative number” field are obtained. The machine word “620C” is obtained as a result of instruction decoding, and executed.

The next instruction code “6322” indicated by the value “02” in the PC field is obtained as follows. First, the short code “6” in the code field 701 and the entry “3” (rc=3#1) for the short code “4” in the encoding field 702 are read. The short code “5” (instruction code “6322”) is pointed at after the command “MOV R0, R2”, the relative position number “3”, and the sorting position number “18” are traced. Decoding of the relative number “5” is carried out based on the above definition as follows.

rc->3#1=3+2->(1#1)+2=(1+2)+2=5 (relative position number)

Then, the machine word “6322” is obtained as a result of instruction decoding, and executed.

The next instruction code “330C” indicated by the value “03” in the PC field is obtained as follows. First, “5” in the short code 701 in FIG. 7 is read. The relative position number “5” ((1+1)+3=5) is obtained for the short code “1” in the coding field 702. The program continues to be executed while it is decoded in a manner as described above.

The decoding is repeated one instruction code after another in a manner as described above until the short code “7” (relative position number “00”) corresponding to the absolute position number “28” (which corresponds to the value “11” in the PC field) in FIGS. 5 and 6 (or “28” in the sorting position number field 410) is reached. Then, the conditional branch instruction BT (89**) is encountered. If the flag is “TRUE” at that time, it is necessary to branch to the current sorting position number “13” (relative position “0”), which corresponds to the value “21” in the PC field and the machine word “620C” and which is indicated by the short code “4”. Therefore, a code indicating the short code “4” (relative position number “0”) is embedded so that it replaces the symbol “**” included in the conditional branch instruction BT (89**). It should be noted that even though the length of the symbol “**” is 8 bits in the original code, it can be of any length in the encoded code. The same coding is carried out when the short code “7” (relative position number “1”) corresponding to the current sorting position number “29” (which corresponds to the value “17” in the PC field) in FIGS. 5 and 6 is reached, and the conditional branch instruction BT (89**) is encountered. Further, the same coding is also carried out when the short code “7” (relative position number “2”) corresponding to the current sorting position number “30” (which corresponds to the value “30” in the PC field) in FIGS. 5 and 6 is reached, and the conditional branch instruction BRA (A***) is encountered. It should be noted that the conditional branch instruction BT (89**) can be discriminated from the conditional branch instruction BT (A***) by referring to the relative position numbers for the short code “7”.

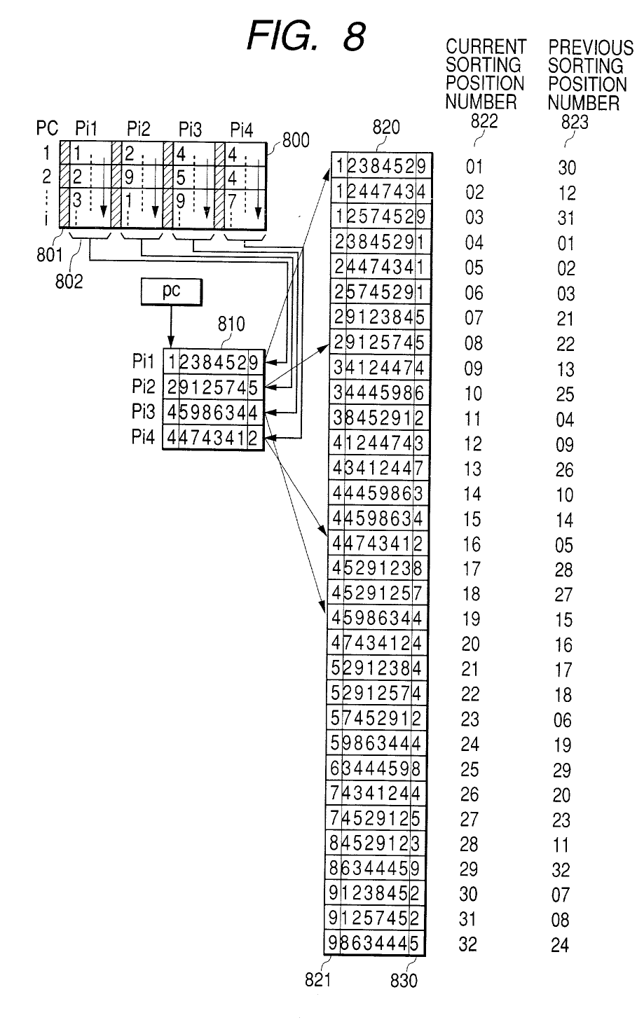

Next, description will be made of compression of program code using instruction sets of the VLIW (Very Long Instruction Word) form. For example, in FIG. 8, each instruction of VLIW is made up of 4 blocks, and the instruction code for each block is indicated by use of a short code to simplify explanation. In a code compression method using the VLIW system according to the present invention, blocks in a same block position such as blocks p1j, p2j, . . . , p1j (j denotes a block position and can be 1, 2, 3, or 4) can be concatenated one after another as shown in block 800 in the figure in order to decode 4 blocks in parallel. It should be noted that the blocks are concatenated after removing the index portion 801 (if there is any) which indicates the positional order of each field. There may be no index portion.

By use of a program counter PC (i=1, . . . , n), cyclic shift strings are created using each of the blocks pi1, pi2, pi3, and pi4, and sorted into arrays.

These arrays are merged and sorted into an array regardless of the block positions. As a result, the array 820 is prepared in which the block positions are disregarded. The array 820 has the current sorting numbers “01” to “32” attached thereto. It should be noted that the codes “12384529”, “29125745”, “45986344”, and “44743412” corresponding to pi1, pi2, pi3, and pi4, respectively, are inserted into their respective sorted positions of the array 820 as indicated by arrows.

Decoding is carried out by specifying 4 parallel position numbers at the same time. That is, by using the last column field 830 of a plurality of instruction code strings in the array 820, a table (as shown in FIG. 6) which indicates the corresponding relationship between the current sorting position number field 822 and the previous sorting position number field 823 is prepared and compression-encoded. The compression-encoded table is decoded in the decoding operation. No problem arises with the decoding operation even though the array is sorted regardless of the block positions since decoding positions are indicated one after another.

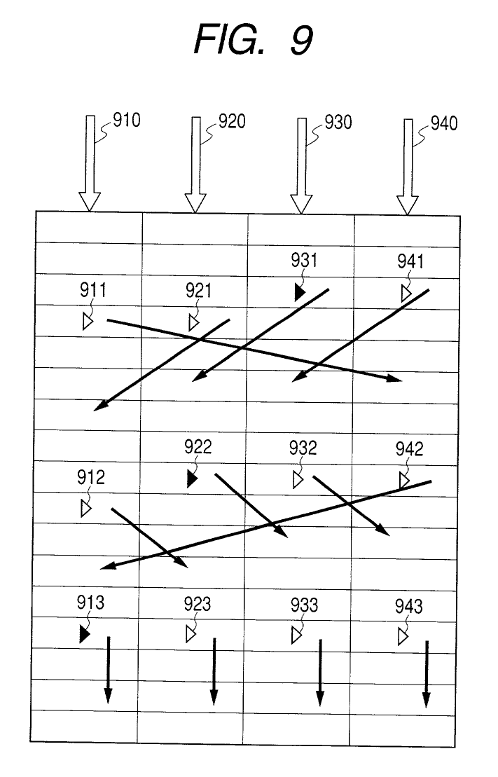

The principle of the parallel program code compression and decoding described above can be applied to not only VLIW but also a single-instruction-code architecture. Specifically, for example, a pseudo-VLIW system is created by dividing serial program code 900 into 4 parallel groups 910, 920, 930, and 940 each corresponding to one of 4 instruction units as shown in FIG. 9. In order to carry out branching without any problem, if any parallel group has a branch instruction, dummy instructions are added to the remaining parallel groups. Specifically, dummy instructions 941, 911, and 921 are added for the original branch instruction 931. Similarly, dummy instructions 932, 942, and 912 are added for the original instruction 922, while dummy instructions 923, 933, and 943 are added for the original instruction 913. With this arrangement, it is possible to pseudo-parallelize the serial program code 900, increasing the decoding speed.

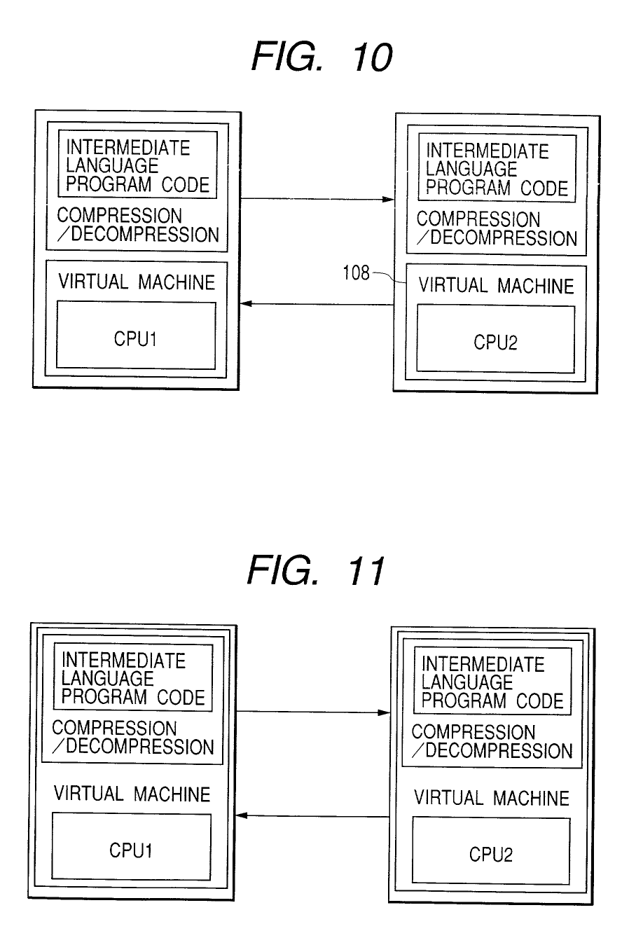

Further, description will be made of a method for compressing virtual code strings written in an intermediate language (for example, a Java language). For example, in the information communication system including virtual machines CPU1 and CPU2 shown in FIG. 10, the processors (CPU1 and CPU2) used in portable phones and personal computers conventionally have architectures having a different instruction set for each of their maker. Their display devices also vary. Furthermore, it is necessary to change the display layout depending on whether the screen size is large or small.

Therefore, by assuming a virtual machine such as a Java machine, virtual program code strings written in the intermediate language and compressed are transmitted or delivered from the CPU 1, which is a transmission side terminal (for example, a base station), to the CPU 2, which is a reception side terminal. Upon receiving the compressed code strings, the reception side terminal decompresses them before interpreting and executing them by use of its built-in processor. Furthermore, the reception side terminal notifies the transmission side terminal of the reception completion of the code strings. The virtual code strings are executed while they are interpreted by an interpreter for a virtual machine written so that the machine can be executed by a specific processor. It is necessary to compress virtual program code strings of large size for storage. Furthermore, program code strings to be transmitted through a communication route of a low transfer rate are also compressed for transmission. Thus, the reception side terminal must decompress and decode the compressed virtual program code strings into the original program code strings, and execute the original program code strings while interpreting them by use of its built-in interpreter, which considerably lowers the execution speed.

The system blocks of the present invention shown in FIG. 11 have similarities to those of the conventional system blocks of FIG. 10. However, its interpreter incorporated in the reception side terminal (CPU2), which corresponds to a virtual machine, is designed to directly decompress, interpret, and execute the compressed code strings of a virtual program in order to prevent the execution speed of the intermediate language from being reduced. That is, short codes which correspond to instruction commands constituting a decompressed and decoded virtual program for a virtual machine are directly linked and executed by an execution program (interpreter) for a specific machine for executing the virtual instructions.

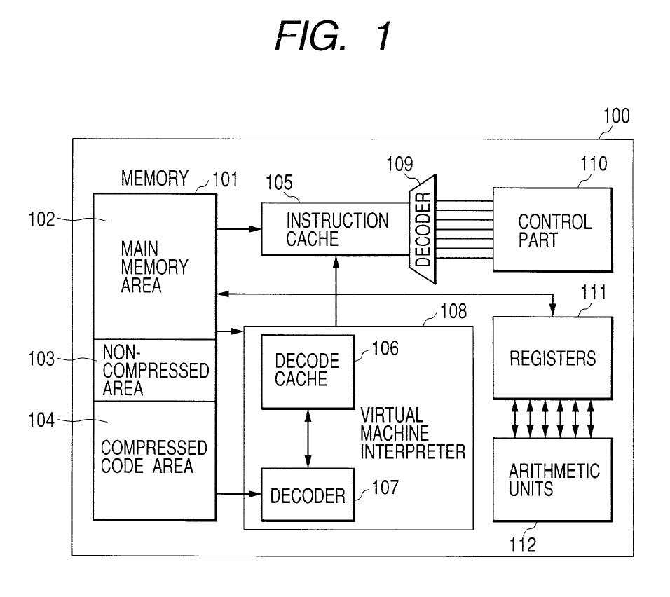

The above descriptions can be turned into a diagram of a processor system configuration such as one shown in FIG. 1. The processor whose configuration is shown in FIG. 1 is the same as that installed in each terminal in FIGS. 10 and 11. A compression section (not shown) creates and stores the compression-encoded program shown in FIG. 2, the table of FIG. 6 created by use of the last column field 430 and indicating the corresponding relationship between the current sorting position number field and the previous sorting position number field, and the table of FIG. 7 indicating the short code field and the encoding field. The compression section is stored in a compressed code area 104 of a memory 101. The compression section also includes the table of FIG. 8 which is created by use of the last column filed 830 and stored after being compressed and which indicates the corresponding relationship between the current sorting position number field 822 and the previous sorting position number field 823. Programs not to be subjected to any compression are stored in the non-compressed area of the memory. Generally, ROMs (Read Only Memories) or non-volatile memories similar to ROMs are used as the compressed code area and the non-compressed area. However, this is not necessarily true with reception side terminals in a transmission/reception system. There is a main memory area which is readable and writable for processing. Since the compressed code of the table 700 shown in FIG. 7 is stored in the compressed code area 104, a decoder 107 is provided to decode the compressed code.

Since part of the decoding processing is performed at high speed and therefore uses caching, a decode cache 106 is provided for that purpose. Instruction codes decoded in the decoder and the decode cache are transmitted to an instruction cache 105, and joined to the decode cache 106 which is a processing section of non-compressed instructions. When a cache miss occurs in the instruction cache 105, the processing returns to a step performed in the decode cache 106. Therefore, when a cache miss has occurred with a branch instruction in the instruction cache, a place in the decode cache in which branch instructions are managed is referenced.

Since the decode cache 106 sorts instructions using a block sorting compression method, they can be gathered and fixed at a specified place when they are stored. The decoder 107 located in a virtual machine interpreter 108 directly interprets the compressed code strings of a virtual program and links it with an execution program when the compressed code strings are decoded. The processor system configuration shown in FIG. 1 further includes: a decoder 109 for interpreting the contents of the instruction cache 105; a control part 110 for controlling the decoder 109; a register 111 for storing and processing data from the main memory area 102; and arithmetic units 112 for performing operations such as addition and subtraction based on the data.

A compression programming method and a processor system using the method according to the present invention can perform decoding operation from a branch destination when a branch instruction is encountered. Therefore, the compression programming method is suitable for program code to be accessed at random. Furthermore, even though conventional compression methods are affected by the fact that the opcode and the operand are different from each other in their occurrence pattern and frequency, the compression method according to the present invention performs compression-encoding regardless of the structure of the instruction (the opcode and the operand), making it possible to obtain a high compression ratio.

Furthermore, program code having a VLIW architecture, which tends to be of large size, is expected to be compressed with high efficiency. Virtual program code can also be compressed and transmitted. The compressed virtual code can be interpreted and executed while it is decoded.

What is claimed is:

1. A compression programming method comprising the steps of:
setting a plurality of codes corresponding to a plurality of commands which constitutes an arbitrary program; and
sorting the plurality of codes by use of a compression algorithm before arranging and compression-encoding the plurality of codes.

2. The compression programming method as claimed in claim 1, wherein the plurality of codes are short codes corresponding to the plurality of commands, and the plurality of codes are sorted according to a defined order.

3. The compression programming method as claimed in claim 1, wherein the compression algorithm is a block sorting compression algorithm.

4. The compression programming method as claimed in claim 1, wherein the compression-encoding step includes a step of:
by use of a last column of the plurality of codes arranged, creating a table which indicates corresponding relationships between current sorting position numbers and previous sorting position numbers, and compressing and storing the table.

5. A compression programming method comprising the steps of:
in an instruction form having a plurality of instruction fields, dividing fields of an instruction into a plurality of instruction blocks, and compressing and sorting the plurality of instruction blocks for each block position;
mixing, merging, and arranging the plurality instruction code strings, for the plurality of instruction code strings after being arranged;
compression-encoding the plurality of instruction code strings arranged; and
performing decoding for each block in parallel at a time of decoding.

6. The compression programming method as claimed in claim 5, wherein the plurality of instruction codes are composed of a plurality of short codes.

7. The compression programming method as claimed in claim 5, wherein the step of compression-encoding includes a step of:
by use of a last column of the plurality of instruction code strings arranged, creating a table which indicates corresponding relationships between current sorting position numbers and previous sorting position numbers, and compressing and storing the table.

8. A processor system using a compression programming method, the processor system comprising:
a setting unit for setting a plurality of codes corresponding to a plurality of commands which constitutes an arbitrary program; and
a compression unit for sorting the plurality of codes by use of a compression algorithm before arranging and compression-encoding the plurality of codes.

9. The processor system as claimed in claim 8, wherein the compression algorithm is a block sorting compression algorithm.

10. The processor system as claimed in claim 8, wherein the plurality of codes are short codes corresponding to the plurality of instruction commands, and the plurality of codes are sorted according to a defined order.

11. The processor system as claimed in claim 8, wherein by use of a last column of the plurality of codes arranged, the compression unit creates and stores a table which indicates corresponding relationships between current sorting position numbers and previous sorting position numbers.

12. A processor system using a compression programming method, the processor system comprising;
a sorting unit for, in an instruction form having a plurality of instruction fields, dividing fields of an instruction into a plurality of instruction blocks, and compressing and sorting the plurality of instruction blocks for each block position;
means for mixing, merging, and arranging the plurality of instruction code strings, for the plurality of instruction code strings after being arranged;
a compression unit for compression-encoding the plurality of instruction code strings arranged; and
a decoding unit for performing decoding for each block in parallel at a time of decoding.

13. The processor system as claimed in claim 12, wherein the plurality of instruction codes are composed of a plurality of short codes.

14. The processor system as claimed in claim 12, wherein by use of a last column of the plurality of instruction code strings arranged, the compression unit creates a table which indicates corresponding relationships between current sorting position numbers and previous sorting position numbers, and compressing and sorting the table.

15. An information communication system for controlling transfer of information such as program code, the information communication system comprising:
a transmission side terminal having an information transfer unit for controlling information transfer as to program code strings compressed by use of a block sorting compression algorithm; and
a reception side terminal for receiving the program code strings subjected to the information transfer;
wherein the reception side terminal is capable of directly decoding and interpreting the program code strings.

16. The information communication system as claimed in claim 15, wherein the program code strings are in an intermediate language, the transmission side terminal is a virtual machine provided in a base station, and the reception side terminal is a portable phone and notifies the transmission side terminal of completion of reception of the program code strings.

17. An information delivery service method for program code, the information delivery service method comprising the steps of:
receiving program code compressed by use of a block sorting compression algorithm and delivered from a transmission side terminal, the step of receiving being performed by a reception side terminal;
after completion of reception of the program code, notifying the transmission side terminal of the completion of reception, the step of notifying being performed by the reception side terminal; and
being capable of directly decoding, interpreting, and executing the program code compressed, the step of being capable of directly decoding being performed by the reception side terminal.

18. The information delivery service method as claimed in claim 17, wherein the reception side terminal is a portable phone having an interpreter therein which interprets the program code strings, whereas the transmission side terminal is a base station for delivering information such as the program code to a user who uses the portable phone.

19. The information delivery service method as claimed in claim 17, wherein the step of being capable of interpreting and executing includes:
a step of being capable of directly decompressing, interpreting, and executing the program code compressed, the step of being capable of directly decompressing being performed by an interpreter incorporated in the reception side terminal.

20. A processor system comprising:
a plurality of memory elements having a compressed instruction area which stores compressed program code;
a processor operating by use of a compression algorithm; and
an interpreter being capable of directly decoding, interpreting, executing the program code by use of the compression algorithm.

21. The processor system as claimed in claim 20, wherein the compression algorithm is a block sorting compression algorithm.
